(19) United States
(12) Patent Application Publication
(10) Pub. No.: US 2010/0238458 A1
(43) Pub. Date: Sep. 23, 2010

(54) TRANSMITTING TERMINAL, PRINTING APPARATUS TERMINAL, PRINTING SYSTEM, DATA TRANSMITTING METHOD, AND PRINT PROCESSING METHOD

(75) Inventors: Kenji Sakuda, Suwa-shi (JP); Yasuhiro Oshima, Matsumoto-shi (JP); Takafumi Higuchi, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORTION, Tokyo (JP)

(21) Appl. No.: 12/727,182

(22) Filed: Mar. 18, 2010

(30) Foreign Application Priority Data
Mar. 19, 2009 (JP) 2009-067968

(51) Int. Cl. G06K 15/02; G06F 3/12

(52) U.S. Cl. 358/1.2; 358/1.15

(57) ABSTRACT

A transmitting terminal carries out communication with a printing apparatus terminal including a print executing unit which prints print data via an IP network.

### CROSS-REFERENCE TO RELATED APPLICATIONS

The entire disclosure of Japanese Patent Application No. 2009-067968, filed Mar. 19, 2009 is expressly incorporated by reference herein.

### BACKGROUND

1. Technical Field

The present invention relates to a transmitting terminal, a printing apparatus terminal, a printing system, a data transmitting method, and a print processing method.

2. Related Art

As a printing system, there is known a personal computer to which a FAX or a printer receiving print data through a communication network such as a telephone line or the Internet to perform printing. The FAX receiving the print data via a telephone line makes reply to a call with a FAX signal and performs printing whenever the FAX receives the print data. Alternatively, the FAX stores the print data in a memory to perform the printing. A personal computer receiving print data via the Internet stores the print data in an external storage device such as a hard disk drive, and then activates a printing application to read the print data stored in the external storage device and perform printing. As a technique of transmitting information via a network, there are known JP-A-2005-109701, JP-A-2003-178028, and JP-A-2005-516320.

In recent years, the next generation network (NGN) has been suggested as an information communication network with the flexibility of the IP (Internet Protocol) network and economy while ensuring the reliability and stability of a known telephone network. In the next generation network, the session initiation protocol (SIP) is used as a protocol which is an application layer for establishing, modifying, and terminating sessions with two or more participants to exchange voices, images, text messages, or the like. The session between apparatuses using the SIP is established by transmitting an INVITE message containing a URI (Uniform Resource Identifier) indicating the network location of an answer terminal requested to establish session from an offer terminal requesting session establishment and by transmitting a status code “a 200 OK” understanding the session establishment of the INVITE message of the offer terminal from the answer terminal. In general, data are exchanged between the terminals establishing the session in such a manner in which a transmitting terminal transmits print contents to a printing apparatus terminal and the printing apparatus terminal receiving the print contents performs printing. However, the capability or the like of the printing apparatus terminal is not sufficiently reflected to the print contents.

### SUMMARY

An advantage of some aspects of the invention is that it provides a transmitting terminal, a printing apparatus terminal, a printing system, a data transmitting method, and a print processing method capable of printing print contents transmitted through an IP network more efficiently.

The aspects of the invention are as follows.

According to an aspect of the invention, there is provided transmitting terminal carrying out communication with a printing apparatus terminal including a print executing unit which prints print data via an IP network. The transmitting terminal includes: a process executing unit which executes a process regarding print contents to be transmitted to the printing apparatus terminal; a first transmitting unit which transmits information; a first receiving unit which receives information; a transmitting connection establishment executing unit which establishes connection with the printing apparatus terminal via the first transmitting unit, the first receiving unit, and the IP network; and a transmitting control unit which allows the first transmitting unit to transmit capability information regarding the process executing unit to the printing apparatus terminal after the establishment of the connection with the printing apparatus terminal, which controls the process executing unit so as to execute the process regarding the print contents on the basis of an execution condition set on the basis of the capability information, when the first receiving unit receives the execution condition of the process executing unit from the printing apparatus terminal after the transmission of the capability information, and which allows the first transmitting unit to transmit the print contents subjected to the process to the printing apparatus terminal.

The transmitting terminal transmits the capability information regarding the process executing unit to the printing apparatus terminal after the establishment of the connection with the printing apparatus terminal via the IP network, executes the process regarding the print contents on the basis of the execution condition upon receiving the execution condition, which is set on the basis of the capability information, of the process executing unit after the transmission of the capability information, and transmits the processed print contents to the printing apparatus terminal. In this way, since the capability information of the transmitting terminal is transmitted to the printing apparatus terminal and the execution condition of the process regarding the print contents is set in the printing apparatus terminal, the print contents which are more suitable for the printing apparatus terminal can be transmitted to the printing apparatus terminal. Accordingly, it is possible to print the print contents more appropriately via the IP network.

In the transmitting terminal according to the aspect of the invention, the transmitting control unit may transmit a reply to a request from the printing apparatus terminal to the printing apparatus terminal, while the transmitting terminal functions as a server in a client-server model after the establishment of the connection with the printing apparatus terminal. In this way, by transmitting and receiving the print contents under the control of the printing apparatus terminal, it is possible to perform the printing by transmitting and receiving the print contents in accordance with the capability of the printing apparatus terminal. Accordingly, it is possible to print the print contents more appropriately via the IP network. Here, the transmitting control unit may transmit the capability information as the reply to the request to the printing apparatus terminal after receiving the request from the printing apparatus terminal or may transmit the print contents as the reply to the request to the printing apparatus terminal after receiving the request from the printing apparatus terminal.

In the transmitting terminal according to the aspect of the invention, the process executing unit may execute a reading process of reading an image of a document to generate the print contents as the process regarding the print contents. The transmitting control unit may transmit at least one of a resolution with which the image is read, a size of the print contents, a readable color kind, and an encoding type with which the print contents are generated to the printing apparatus terminal as the capability information and controls the process executing unit to execute the reading process on the basis of the execution condition upon receiving the execution condition of the process executing unit. With such a configuration, since the printing apparatus can receive the print contents subjected to the reading process of the image in accordance with the capability of the printing apparatus terminal, it is possible to print the print contents more appropriately. At this time, the transmitting control unit may detect the document before the transmission of the capability information, may acquire document information containing at least one of a document size and an image kind of the document, and may transmit the capability information restricted in accordance with a range corresponding to the document information to the printing apparatus terminal. With such a configuration, since the more suitable capability information can be transmitted using the document information, it is possible to print the print contents more appropriately.

In the transmitting terminal according to the aspect of the invention, the process executing unit may execute a changing process of changing at least one of a resolution, an image size, a color kind, and an encoding type of image data as the process regarding the print contents. The transmitting control unit may transmit at least one of the resolution, the image size, the color kind, and the encoding type changeable by the process executing unit to the printing apparatus terminal and may control the process executing unit so as to execute the changing process on the basis of the execution condition upon receiving the execution condition of the process executing unit. With such a configuration, since the printing apparatus can receive the print contents subjected to the reading process of the image in accordance with the capability of the printing apparatus terminal, it is possible to print the print contents more appropriately.

According to another aspect of the invention, there is provided a printing apparatus terminal carrying out communication with a transmitting terminal including a process executing unit executing a process regarding print contents via an IP network. The printing apparatus terminal includes: a print executing unit which prints print data; a second transmitting unit which transmits information; a second receiving unit which receive information; a receiving connection establishment executing unit which establishes connection with the transmitting terminal via the second transmitting unit, the second receiving unit, and the IP network; and a receiving control unit which sets an execution condition of the process executing unit on the basis of capability information and setting regarding the print executing unit, when the second receiving unit receives the capability information after the establishment of the connection with the transmitting terminal, which allows the second transmitting unit to transmit the set execution condition to the transmitting terminal, and which controls the print executing unit to print print contents processed by the process executing unit on the basis of the setting regarding the print executing unit, when the second receiving unit receives the print contents after the transmission of the execution condition.

The printing apparatus terminal receives the capability information regarding the process executing unit after the establishment of the connection with the transmitting terminal via the IP network, sets the execution condition of the process executing unit on the basis of the capability information and the setting regarding the print executing unit upon receiving the capability information regarding the process executing unit, transmits the execution condition to the transmitting terminal, prints the print contents on the basis of the setting regarding to the print executing unit after transmitting the transmission of the execution condition and then receiving the print contents processed by the process executing unit. In this way, since the capability information of the transmitting terminal is received and the execution condition of the process regarding the print contents is set in the printing apparatus terminal, the print contents which are more suitable for the printing apparatus terminal can be received by the printing apparatus terminal. Accordingly, it is possible to print the print contents more appropriately via the IP network.

The receiving control unit may transmit a request to the transmitting terminal, while the printing apparatus terminal functions as a client in a client-server model after the establishment of the connection with the transmitting terminal. In this way, by transmitting and receiving the print contents under the control of the printing apparatus terminal, it is possible to perform the printing by transmitting and receiving the print contents in accordance with the capability of the printing apparatus terminal. Accordingly, it is possible to print the print contents more appropriately via the IP network. Here, the receiving control unit may transmit the request of the capability information of the transmitting terminal to the transmitting terminal after the establishment of the connection with the transmitting terminal. Alternatively, the receiving control unit may transmit a request for transmitting the print contents to the transmitting terminal after transmitting the execution condition.

In the printing apparatus terminal according to the aspect of the invention, the receiving control unit may set the execution condition by using at least one of a print quality, a kind of print medium on which printing is executed, and a size of the print medium as the setting regarding the print executing unit.

According to still another aspect of the invention, there is provided a printing system connected via an IP network includes: the transmitting terminal having the above-described configuration; and the printing apparatus terminal having the above-described configuration. Since the transmitting terminal having the above-described configuration and the printing apparatus terminal having the above-described configuration can print the print contents via the IP network more appropriately, the same advantages can be obtained in the printing system including the transmitting terminal and the printing apparatus terminal.

In the printing system according to the aspect of the invention, the IP network may be a next generation network (NGN). The connection between the transmitting terminal and the printing apparatus terminal may be established by a session initiation protocol (SIP).

According to still another aspect of the invention, there is provided a data transmitting method of using a transmitting terminal including a process executing unit executing a process regarding print contents to be transmitted to a printing apparatus terminal and carrying out communication with the printing apparatus terminal including a print executing unit which prints print data via an IP network. The data transmitting method includes: (a) establishing connection with the printing apparatus terminal via the IP network; (b) transmitting capability information regarding the process executing unit to the printing apparatus terminal after establishing the connection with the printing apparatus terminal in (a) the establishing; (c) receiving an execution condition of the process executing unit, which is set on the basis of the capability information, of the process executing unit from the printing apparatus terminal after transmitting the capability information in (b) the transmitting; and (d) controlling the process executing unit so as to execute a process regarding the print contents on the basis of the execution condition when receiving the execution condition in (c) the receiving and transmitting the processed print contents to the printing apparatus terminal.

In the data transmitting method, like the transmitting terminal, the capability information of the transmitting terminal is transmitted to the printing apparatus terminal and the execution condition of the process regarding the print contents is set in the printing apparatus terminal, the print contents which are more suitable for the printing apparatus terminal can be transmitted to the printing apparatus terminal. Accordingly, it is possible to print the print contents more appropriately via the IP network. The data transmitting method may be modified in various forms so as to be suitable for the above-described transmitting terminal. Alternatively, a step of realizing each function of the above-described transmitting terminal may further be added.

According to sill another aspect of the invention, there is provided a printing method of using a printing apparatus terminal including a print executing unit which prints print data and carrying out communication with a transmitting terminal including a process executing unit executing a process regarding print contents via the IP network. The printing method includes: (e) establishing connection with the transmitting terminal via the IP network; (f) receiving capability information regarding the process executing unit after establishing the connection with the transmitting terminal in (e) the establishing; (g) setting an execution condition of the process executing unit on the basis of the capability information and setting regarding the print executing unit when receiving the capability information in (f) the receiving and transmitting the set execution condition to the printing terminal; and (h) controlling the print executing unit so as to print print contents processed by the process executing unit on the basis of the setting regarding the print executing unit when receiving the print content after the transmission of the executing condition in (g) the transmitting.

In the printing method, like the printing apparatus terminal, the capability information of the transmitting terminal is transmitted to the printing apparatus terminal and the execution condition of the process regarding the print contents is set in the printing apparatus terminal, the print contents which are more suitable for the printing apparatus terminal can be received by the printing apparatus terminal. Accordingly, it is possible to print the print contents more appropriately via the IP network. The printing method may be modified in various forms so as to be suitable for the above-described printing apparatus terminal. Alternatively, a step of realizing each function of the above-described printing apparatus terminal may further be added.

According to still another aspect of the invention, there is provided a program causing one or a plurality of computers to realize the steps of the data transmitting method and the printing method described above. The program may be recorded in a computer readable recording medium (for example, a hard disk drive, a ROM, an FD, a CD, or a DVD), may be delivered to a computer to another computer via a transmission medium (such as the Internet or a communication network such as the LAN), or may be transmitted or received in any communication form. When the program is executed so that the steps are executed in one computer or are distributed into the plurality of computer, the steps of the data transmitting method and the printing method described above are executed. Accordingly, the same advantages as those of the above-described methods can be obtained.

### BRIEF DESCRIPTION OF THE DRAWINGS

The invention will be described with reference to the accompanying drawings, wherein like numbers reference like elements.

FIG. 1 is an explanatory diagram illustrating an IP network, a transmitting terminal, and a printing apparatus terminal.

FIG. 2 is a flowchart illustrating an exemplary routine of a reading data transmitting process.

FIG. 3 is a flowchart illustrating an exemplary routine of a reading data print processing process.

FIG. 4 is an explanatory diagram illustrating a transmitting and receiving sequence of print contents data.

FIG. 5 is an explanatory diagram illustrating an example of the details of an SDP of an INVITE message.

FIG. 6 is an explanatory diagram illustrating an example of the details of the SDP of a 200 OK message.

FIG. 7 is an explanatory diagram illustrating an example of the details of a capability request.

FIG. 8 is an explanatory diagram illustrating an example of a capability setting information.

FIG. 9 is an explanatory diagram illustrating an example of the details of a capability reply.

FIG. 10 is an explanatory diagram illustrating an example of a reading execution condition.

FIG. 11 is an explanatory diagram illustrating an example of reading print condition setting information.

FIG. 12 is an explanatory diagram illustrating an example of another capability setting information.

### DESCRIPTION OF EXEMPLARY EMBODIMENTS

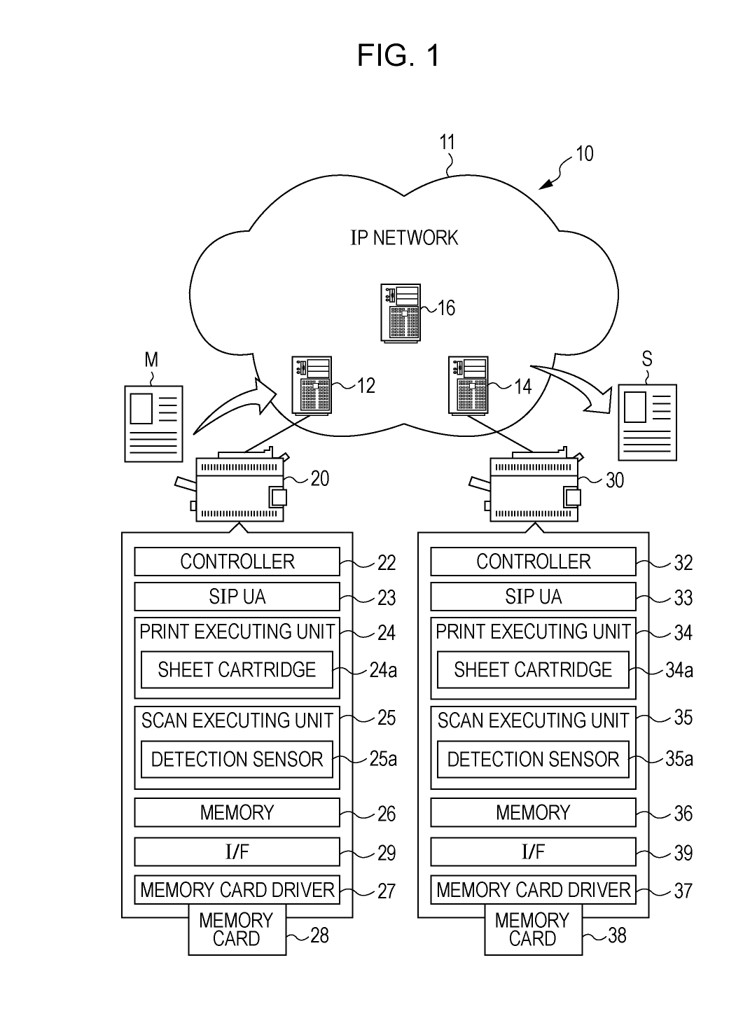

Hereinafter, an embodiment of the invention will be described with reference to the drawings. FIG. 1 is a diagram illustrating of an exemplary configuration of a printing system 10 in which printers 20 and 30 functioning as a transmitting terminal and printing apparatus terminal are connected to each other on an IP (Internet Protocol) network 11 according to an embodiment of the invention. As illustrated, the printers 20 and 30 are connected to SIP (Session Initiation Protocol) proxy servers 12 and 14 constructing the IP network 11.

The IP network 11 serving as the next generation network (NGN), for example, is constructed by the SIP proxy server 12 and 14 and a location server 16. The SIP proxy servers 12 and 14 have a function of relaying an IP message and a registry function of registering location information (for example, the URI (Uniform Resource Identifier)) of user agents of the printers 20 and 30 in the location server 16.

The printers 20 and 30 are a complex apparatus functioning as both a scanner and a printer and include: controllers 22 and 32 controlling the apparatus as a whole; user agents (SIP UA) 23 and 33 for a session initiation protocol (SIP); print executing units 24 and 34 printing characters, image data, or the like; scan executing units 25 and 35 scanning characters or images formed on a medium such as a document M to make the scanned characters or images into image data; memories 26 and 36 storing data to be printed or storing the image data obtained by the scanning; memory card drivers 27 and 37 writing data in memories of memory cards 28 and 38 or reading the data stored in the memory cards 28 and 38 when the memory cards 28 and 38 are connected; and network interfaces (I/F) 29 and 39 connected to the IP network 11 and capable of transmitting and receiving signals to and from an external apparatus, respectively. The print executing units 24 and 34 serve as an ink jet mechanism capable of executing printing by pressurizing pressure to each color ink and ejecting the pressurized ink to a print sheet. The mechanism pressurizing the pressure to the ink may be a mechanism pressurizing the pressure by deformation of piezoelectric elements or a mechanism generating bubbles by the heat of a heater. The print executing units 24 and 34 include plural sheet cartridges 24a and 34a accommodating print sheets as print media, respectively. The scan executing units 25 and 35 is a flatbed type scanner scanning a so-called line image sensor and reading the document. The scan executing units 25 and 35 include detecting sensors 25a and 35a capable of detecting the size of the document M.

Next, the operation of the IP network 11 having the above-described configuration according to this embodiment of the invention will be described. In particular, a process of transmitting the print contents from the printer 20 and printing the print contents by the printer 30 will be described. Specifically, a process will be mainly described such that the printer 20 scans the document M to generate the print contents data by the operation of a user of the printer 20 and the print contents data are form the printer 20 to the printer 30 through the IP network 11, and the printer 30 receiving the print contents data prints the print contents data so that the user of the printer 30 obtains a printing product S. Hereinafter, for convenient description, the printer 20 is termed “a transmitting terminal 20” and the printer 30 is termed “a printing apparatus terminal 30”. First, the user sets the document M to the scan executing unit 25 of the transmitting terminal 20, inputs a unique number assigned to the printing apparatus terminal 30, which is a transmission destination” by operating an operation panel (not shown), and presses down a transmission button (not shown). Then, the controller 22 of the transmitting terminal 20 executes a routine of the reading data transmitting process.

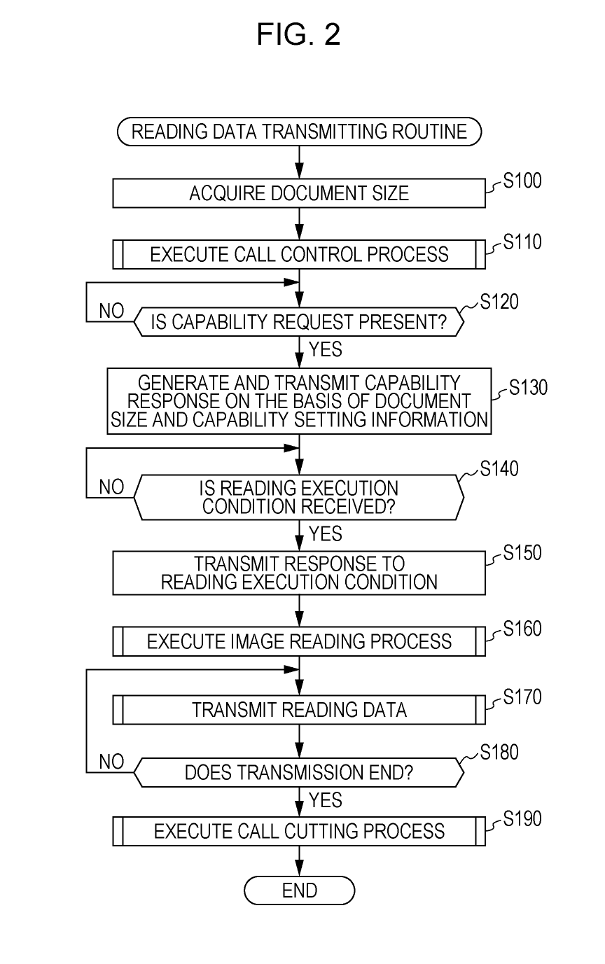

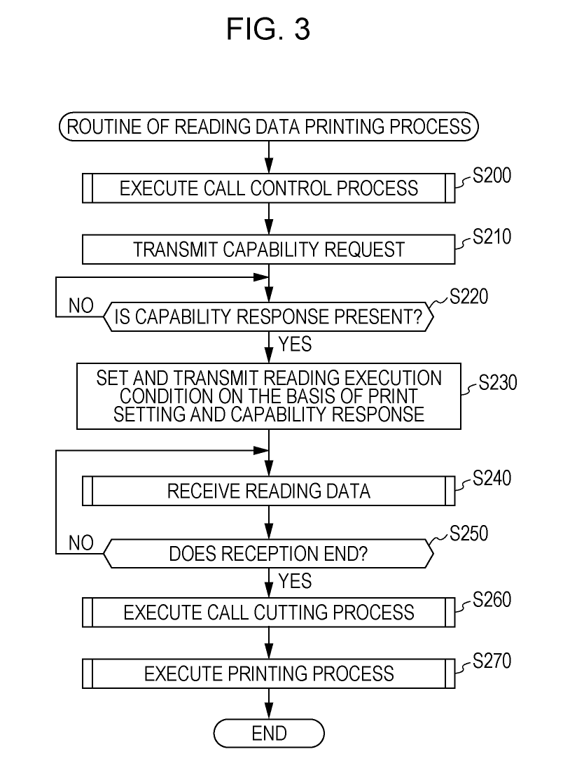

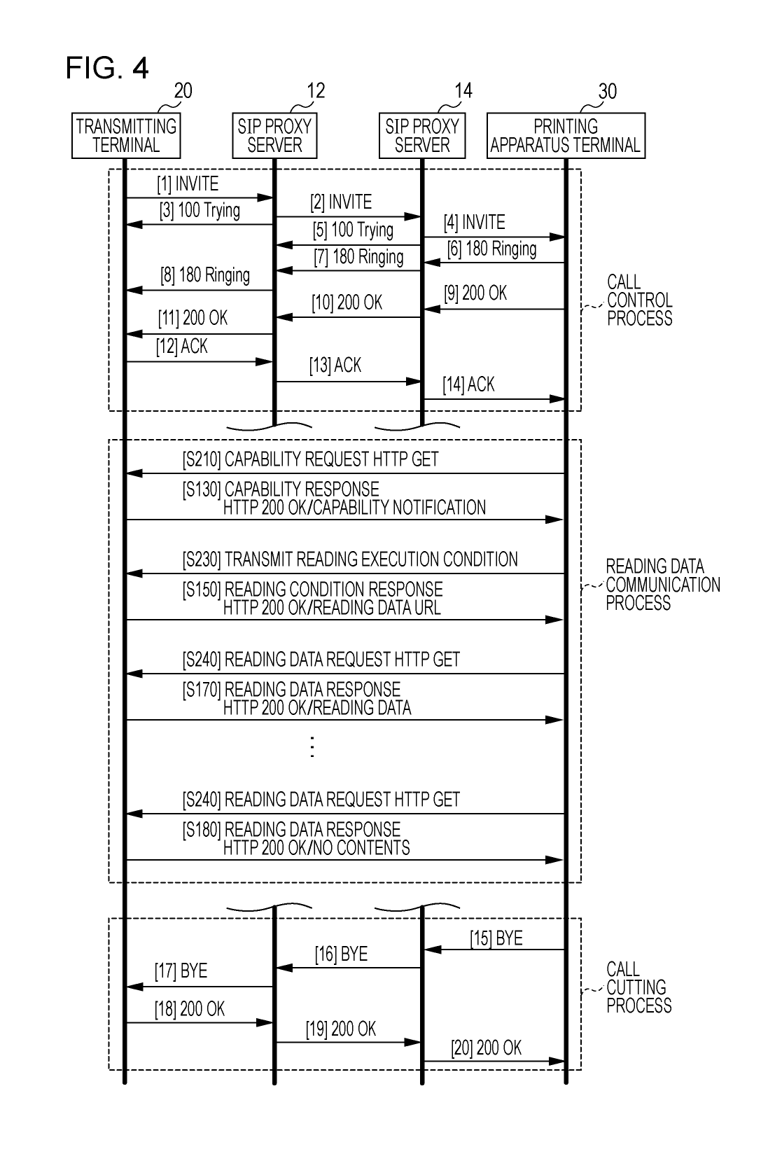

FIG. 2 is a flowchart illustrating an exemplary the routine of the reading data transmitting process executed by the controller 22 of the transmitting terminal 20. FIG. 3 is a flowchart illustrating an exemplary routine of the reading data printing process executed by the controller 32 of the printing apparatus terminal 30. FIG. 4 is an explanatory diagram illustrating a transmitting and receiving sequence of the print contents data. Hereinafter, the routine of the reading data transmitting process in FIG. 2 and the routine of the reading data printing process in FIG. 3 will be mainly described, and the sequence of FIG. 4 will be properly described. When the routine of the reading data transmitting process is executed, the controller 22 acquires the size of the document M on the basis of a detection signal from the detecting sensor 25a (S100). Here, the detecting sensor 25a can normal documents with the A3, B4, A4, B5, and A5 sizes used generally for a document, a postcard used generally for an image such as photo, and documents with the 2L and L sizes. Subsequently, the controller 22 executes a call control process on the basis of the unique number input by the user (step S110). The call control process is described below.

FIG. 4 is an explanatory diagram illustrating a communication sequence between the transmitting terminal 20 and the printing apparatus terminal 30 by the session establishment protocol when the image data formed by the scanning of the transmitting terminal 20 is transmitted as the print contents data from the transmitting terminal 20 to the printing apparatus terminal 30 and the printing apparatus terminal 30 receiving the image data prints the image data. The session establishment by the SIP is initiated by the INVITE message transmitted from the transmitting terminal 20 to the printing apparatus terminal 30. The INVITE message from the transmitting terminal 20 is first transmitted to the SIP proxy server 12. The SIP proxy server 12 replies a “100 Trying”, which is a status code indicating the period of the process, to the transmitting terminal 20 and transmits the INVITE message to the SIP proxy server 14 on the basis of the URI of the printing apparatus terminal 30 described in the INVITE message. The SIP proxy server 14 replies a “100 Trying”, which is a status code indicating the period of the process, to the SIP proxy server 12 and transmits the INVITE message to the printing apparatus terminal 30 on the basis of the URI of the printing apparatus terminal 30 described in the INVITE message. The printing apparatus terminal 30 replies an “180 Ringing”, which is a status code meaning the period of a call in response to the reception of the INVITE message. The “180 Ringing” is transmitted to the transmitting terminal 20 via the SIP proxy server 14 and the SIP proxy server 12. Subsequently, when the printing apparatus terminal 30 transmits a “200 OK”, which is a status code meaning a success of the call generated to establish the session for the INVITE message received by the printing apparatus terminal 30, the “200 OK” is transmitted to the transmitting terminal 20 via the SIP proxy server 14 and the SIP proxy server 12. The transmitting terminal 20 receiving the “200 OK” transmits an “ACK”, which is a status code confirming the reception of the final reply for the INVITE message, to the printing apparatus terminal 30 via the SIP proxy server 12 and the SIP proxy server 14. The connection between the transmitting terminal 20 and the printing apparatus terminal 30 is established, and thus it is ready to transmit the print contents data from the transmitting terminal 20 to the printing apparatus terminal 30.

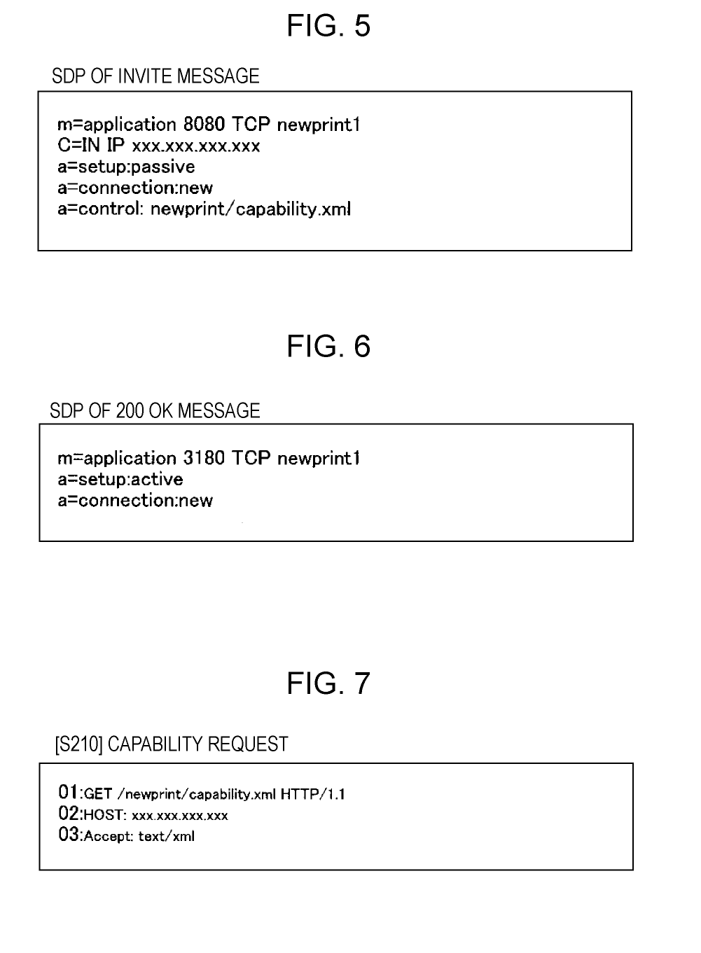

FIG. 5 is a diagram illustrating an example of the details of a SDP (Session Description Protocol) in the INVITE message transmitted from the transmitting terminal 20 according to the embodiment. FIG. 6 is a diagram illustrating an example of the details of the SDP in the “200 OK” message transmitted from the printing apparatus terminal 30 according to the embodiment. The SDP in FIGS. 5 and 6 contains a media description part. In the SDP, an “m=” line represents information on a kind of media or transport address. The “m=” line in FIG. 5 means that an application defined by payload type “newprint1” using “TCP (Transmission Control Protocol)” is treated as port number “8080”. An “m=” line in FIG. 6 means that an application defined by payload type “newprint1” using “TCP” is treated as port number “3180”. In this embodiment, “newprint1” in the “m=” line describes the fact of identifying the transmission and reception of the print contents data. According to the description of “newprint1”, the transmitting terminal 20 functions as a server in the client-server model and the printing apparatus terminal 30 function as a client in the client-server model. The transmitting terminal 20 is known to function as “a passive side” (server) from the description of “a=setup: passive” in FIG. 5. The printing apparatus terminal 30 is known to function as “an active side” (client) from the description of “a=setup: active” in FIG. 6. In the SDP, a “C=” line represents the address of a media contained in the session. The “C=” line in FIG. 5 describes “IN IP xxx.xxx.xxx.xxx” and thus it can known that the IP address of the transmitting terminal 20 is “xxx.xxx.xxx.xxx”. The last line “a=” line in FIG. 5 describes “newprint/capability.xml” meaning the URL of an initial request destination from the printing apparatus terminal 30 after the session establishment. According to this description, the printing apparatus terminal 30 functioning as the client in the client-server model can initially acquire the URL of a capability request made for the transmitting terminal 20.

When the session is established in the call control process in step S110, the controller 22 waits until the controller 22 receives the capability request from the printing apparatus 30 (step S120). The capability request is a request for transmitting information regarding the capability of the print executing unit 24 or the scan executing unit 25 of the transmitting terminal 20 to the printing apparatus terminal 30. FIG. 7 is an explanatory diagram illustrating an example of the details of the capability request. Line 01 of a capability request message represents a command indicating a “request”, Line 02 represents the IP address of the transmitting terminal 20 obtained from the INVITE message, and Line 03 represents the reception of an XML text. When the transmitting terminal 20 receives the capability request from the printing apparatus terminal 30, the controller 22 generates a capability reply on the basis of the acquired document size and capability setting information 26a and transmits the generated capability reply to the printing apparatus terminal 30 via the I/F 29 (step S130).

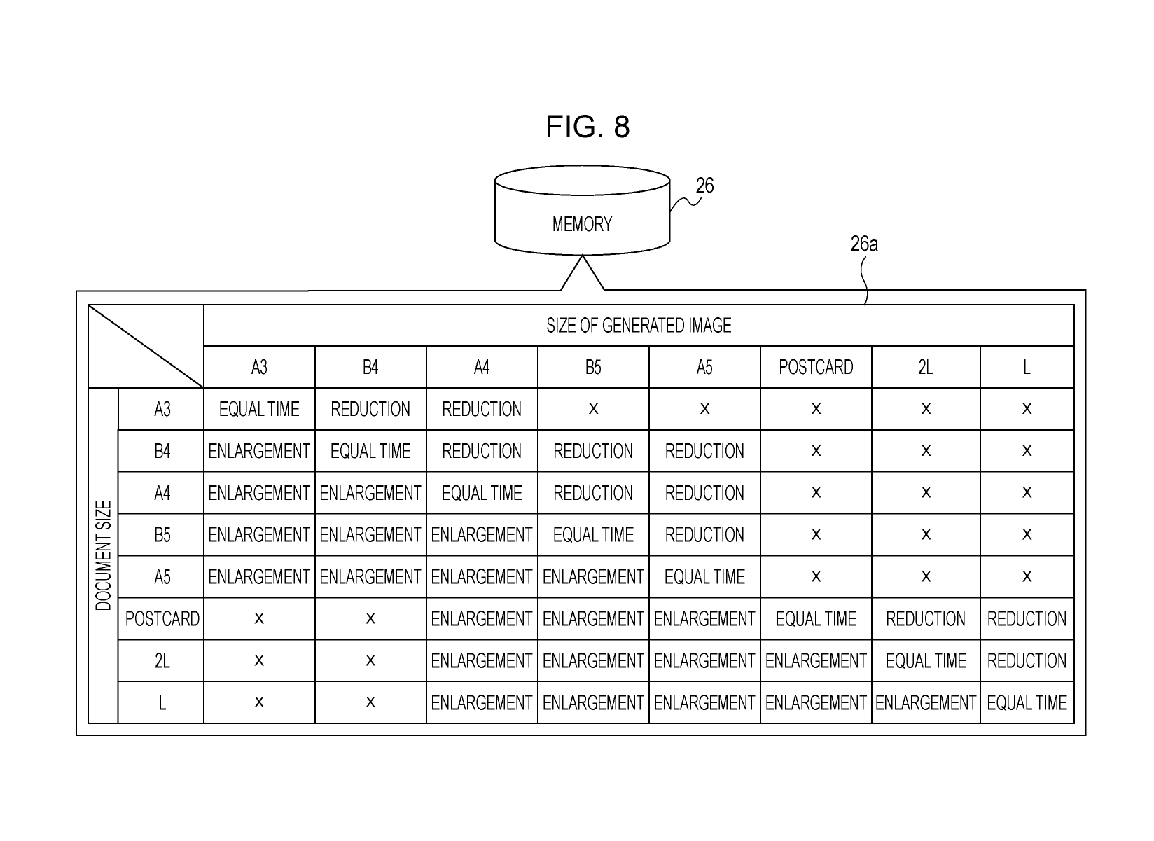

Hereinafter, the generation of the capability rely will be described. The capability reply includes a resolution with which the scan execution unit 25 reads an image, the sizes of the generable image data, color kinds of readable color or monochrome, and encoding types such as tiff or jpeg with which the print contents are generated. In the print system 10, the printing apparatus terminal 30 selects capabilities suitable for performing the printing by the printing apparatus terminal 30 among the capabilities of the transmitting terminal 20 included in the capability reply. Therefore, the capabilities of the transmitting terminal 20 which are not suitable for the document M are omitted and the capability rely of which the range is restricted is generated. FIG. 8 is an explanatory diagram illustrating an example of the capability setting information 26a. In the capability setting information 26a, the range of the generated image size is set so as to be allowed to enlarge and reduce the size of the document M. The mark “x” shown in FIG. 8 represents that the size of the image enlarged or reduced is not generated. For example, when the size of the document M is A4, the generation of the image data with a size enlarged to an A3 or B4 size or reduced to a B5 or A5 size is allowed. In addition, the generation of the image data with a size reduced up to a postcard size or a 2L or L size for a photo can be possible in effect, but is set to be not allowed as the capability. In this way, for example, when the document is a text document in the printing apparatus terminal 30, it is possible to prevent a printing product from being too reduced to the degree that characters are too small to be read, or it is possible to prevent a printing product from being too enlarged to the degree that characters are too large and thus the image quality deteriorates. Here, when the document M has the A4 size, the capability reply capable of generating the image data with the A3, B4, A4, B5, and A5 sizes are generated and transmitted to the printing apparatus terminal 30.

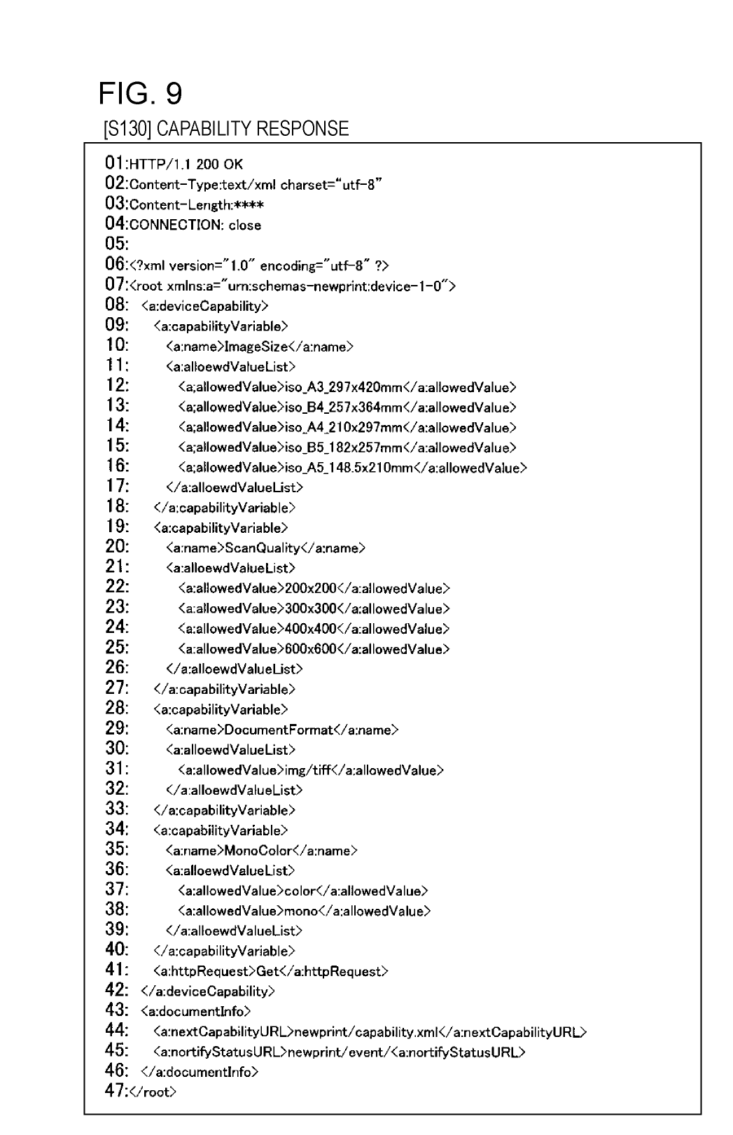

FIG. 9 is an explanatory diagram illustrating an example of a capability reply message. Here, Line 01 of the capability reply message describes a “200 OK” meaning a success to the request, Line 02 describes the fact that a type of contents is an XML text, and Line 03 represents the length of the contents. From this example, it can be known that as the capability of the transmitting terminal 20, the generable sizes (“ImageSize” in Line 10) of the image are the A3, B4, A4, B5, and A5 sizes (Lines 12 to 16), the reading resolutions (“ScanQuality” in Line 20) are 200×200 dpi, 300×300 dpi, 400×400 dpi, and 600×600 dpi (Lines 22 to 25), the type of encode (“DocumentFormat” in Line 29) is tiff (“img/tiff in Line 29), and the color kinds (MonoColor” in Line 35) are color and monochrome (Lines 35 and 36). Line 44 in the capability reply message describes the next URL when page information is requested from the printing apparatus terminal 30. This URL is a participant address from the IP address “xxx.xxx.xxx.xxx (“HOST: xxx.xxx.xxx.xxx in Line 02 in FIG. 7) of the transmitting terminal 20 described in the SDP of the INVITE message. Line 45 describes a URL (“newprint/event/”) for receiving status change information. The URL for receiving status change information is a URL used for the printing apparatus terminal 30 to receive information when a status different from a normal status of the printing apparatus terminal 30 occurs, for example, sheet jamming occurs or ink is used up.

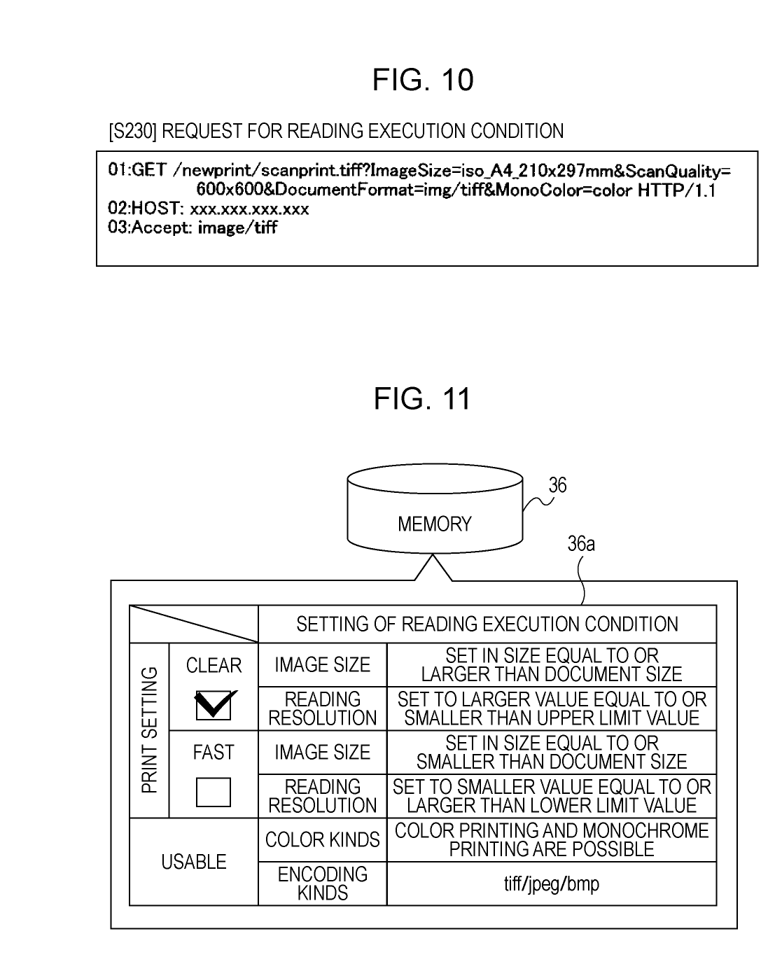

When the capability reply is transmitted in step S130, the controller 22 waits until the controller 22 receive a reading execution condition (step S140). As described in detail below, the reading execution condition includes a resolution with which an image is read, the size of the image data, a kind of color or monochrome, and an encoding type such as tiff or jpeg. FIG. 10 is an explanatory diagram illustrating an example of the reading execution condition. Here, as for the required reading execution condition, the image size “ImageSize” is the A4 size, the reading resolution “ScanQuality” is 600×600 dpi, the encoding type “DocumentFormat” is tiff, and the kind of color “MonoColor” is a color. When the controller 22 receives the reading execution condition, the controller 22 transmits a reply to this reading execution condition to the printing apparatus terminal 30 (step S150), and then executes the image reading process (step S160). The image reading process is performed by scanning the line image sensor (not shown) by the scan executing unit 25, by reading the document M with the resolution included in the reading execution condition, and generating the image size included in the reading execution condition and the image data in accordance with the encoding type. Subsequently, the controller 22 executes a reading data transmitting process of transmitting the generated image data as the print contents data to the printing apparatus terminal 30 via the I/F 29 and the IP network 11 (step S170).

In a reading data communication process, as shown in FIG. 4, the data is requested when the printing apparatus terminal 30 transmits a message for requesting the reading data by using the acquired URL (step S240). On the other hand, when the transmitting terminal 20 receives the message for requesting the reading data from the printing apparatus terminal 30 via the I/F 29, the controller 22 transmits a data reply message and the print contents data as the reply to the message for requesting the reading data to the printing apparatus terminal 30 via the I/F 29 (step S170). In this way, the transmitting terminal 20 functions as a server in the client-server model and the printing apparatus terminal 30 functions as a client in the client-server model to transmit and receive the data.

Subsequently, the controller 22 determines whether the transmission of the print contents ends on the basis of existence or non-existence of the print contents in a non-transmitted state (step S180). When it is determined that the transmission of the print contents does not end, the reading data transmitting process in step S170 continues. Alternatively, when it is determined that the transmission of the print contents ends, a call cutting process is executed (step S190), and then this routine ends. In the call cutting process, as shown in FIG. 4, “BYE”, which is a status code for terminating the session, is transmitted from the printing apparatus terminal 30 to the transmitting terminal 20 via the SIP proxy server 14 and the SIP proxy server 12. Then, the session is terminated by transmitting the “200 OK” from the transmitting terminal 20 to the printing apparatus terminal 30 via the SIP proxy server 12 and the SIP proxy server 14. Moreover, by executing the establishment and the termination of the session via the SIP proxy server 12 and the SIP proxy server 14, an administrator managing the SIP proxy server 12 and the SIP proxy server 14 acquires the time of the establishment of the session and the time of the termination of the session between the transmitting terminal 20 and the printing apparatus terminal 30 to calculate the price (billing) of the service for the establishment of the session between the transmitting terminal 20 and the printing apparatus terminal 30.

Next, the process in the printing apparatus terminal 30 will be described. The above-described step numbers or the numbers are used and the repeated description is omitted. When a message for the call control process (S110) is received from the transmitting terminal 20, the controller 32 of the printing apparatus terminal 30 executes the routine of the reading data printing process shown in FIG. 3. When this routine is initiated, the controller 32 executes the call control process (step S200). When the session with the transmitting terminal 20 is established, the controller 32 transmits the capability request (see FIG. 7) to the transmitting terminal 20 via the I/F 39 (step S210) and then waits until receiving the capability reply (step S220). When the controller 32 receives the capability reply (see FIG. 9) via the I/F 39, the controller 32 sets the reading execution condition on the basis of the print setting, the sheet size set in the print executing unit 34, and the details of the received capability reply and transmits the set reading execution condition to the transmitting terminal 20 via the I/F 39 (step S230). Hereinafter, the setting of the reading execution condition will be described.

FIG. 11 is an explanatory diagram illustrating an example of reading print condition setting information 36a. The reading print condition setting information 36a contains information regarding the current print setting of the printing apparatus terminal 30, a method of setting the reading execution condition in accordance with the print setting, or the like. The reading print condition setting information 36a contains print qualities “clear” and “fast” as the information regarding the current print setting. Here, “clear” is set. Since a print medium with the same size as that of the document M is not set in the sheet cartridges 34a, the image size read and generated by the scan executing unit 25 is set in the reading print condition setting information 36a. When the print setting is “clear” in the reading print condition setting information 36a, the reading execution condition is set such that the reading resolution is set to a larger value equal to smaller than the upper limit value of the capability of the transmitting terminal 20 without considering a reading speed and the image is read as precisely as possible. Moreover, when the print setting is “clear”, a size, which is equal to or larger than the size of the sheet size among the print sheets set in the sheet cartridges 34a and is the closest to the document size, is set as the size of the image data. In this way, a clearer printing product can be obtained, compared to a printing product with a size smaller than the document size. Alternatively, when the print setting is “fast”, the reading execution condition is set such that the reading resolution is set to a smaller value, which is equal to or larger than the lower limit value of the capability of the transmitting terminal 20, without considering the image quality, the reading speed is set as fast as possible, and the capacity is set as small as possible. Moreover, when the print setting is “fast”, a size, which is equal to or smaller than the size of the sheet among the print sheets set in the sheet cartridges 34a and is the closest to the document size, is set as the size of the image data. In this way, the printing process can be executed faster, compared to a printing product with a size larger than the document size. As the other reading execution conditions, the document M is a color. When a color printing process can be executed by the printing execution unit 34, “color” is set as the color kind and “tiff” available in the transmitting terminal 20 is set as the encoding type. In this way, when the reading execution conditions are set, the controller 32 transmits the reading execution conditions to the transmitting terminal 20 via the I/F 39.

Subsequently, the controller 32 executes the reading data receiving process (step S240). Here, since the printing apparatus terminal 30 functions as a client in the client-server model, the printing apparatus terminal 30 transmits the message for requesting the reading data to the transmitting terminal 20. The transmitting terminal 20 receiving this message reads the document M under the reading execution conditions set by the printing apparatus terminal 30, generates the image data, and then transmits the image data to the printing apparatus terminal 30 (S170). The controller 32 determines whether the reception of the print contents ends on the basis of whether information indicating no contents is received from the transmitting terminal 20 (step S250). When it is determined that the reception of the print contents does not end, the controller 32 executes the process of step S240. Alternatively, when it is determined that the reception of the print contents ends, the call cutting process is executed (step S260), the printing process of the received print contents is executed (step S270), and then this routine ends. In the printing process, for example, a sheet feeding roller (not shown) is driven, the print sheet is fed from the sheet cartridge 34a accommodating the print sheets in accordance with the size of the image data of the print contents, ink is ejected to the print sheet to form an image on the basis of the image data while the print sheet is transported. In this way, in the printing system 10, when the print contents read and generated by the transmitting terminal 20 are printed by the printing apparatus terminal 30 through the IP network 11, the reading execution conditions of the transmitting terminal 20 are set in the printing apparatus terminal 30 so that the printing apparatus terminal 30 prints the obtained print contents.

Here, the constituent elements according to this embodiment correspond to the constituent elements according to the invention as follows. The scan executing unit 25 according to this embodiment corresponds to a process executing unit according to the invention. The I/F 29 corresponds to a first transmitting unit and a first receiving unit. The controller 22 and the SIP UA 23 correspond to a transmitting connection establishment executing unit according to the invention. The controller 22 corresponds to a transmitting control unit. The print executing unit 34 corresponds to a print executing unit according to the invention. The I/F 39 corresponds to a second transmitting unit and a second receiving unit. The controller 32 and the SIP UA 33 correspond to a receiving connection establishment executing unit according to the invention. The controller 32 corresponds to a receiving control unit. The capability reply corresponds to capability information. The reading execution condition corresponds to an execution condition of a process regarding print contents. In this embodiment, an example of a data transmitting method is apparent from the description of the processes of the transmitting terminal 20. Moreover, an example of a printing method is apparent from the description of the processes of the printing apparatus terminal 30.

In the printing system 10 according to the above-described embodiment, the connection with the printing apparatus terminal 30 is established by the SIP via the IP network 11 as the NGN. The transmitting terminal 20 transmits the capability reply of the scan executing unit 25 to the printing apparatus terminal 30. The printing apparatus terminal 30 receiving the capability reply sets the reading execution condition of the scan executing unit 25 on the basis of the capability reply and the setting regarding the print executing unit 34 and transmits the reading execution condition to the transmitting terminal 20. The transmitting terminal 20 receiving the reading execution condition executes the reading process on the basis of the reading execution condition and transmits the read print contents to the printing apparatus terminal 30. The printing apparatus terminal 30 receiving the print contents prints the print contents on the basis of the setting regarding the print executing unit 34. In this way, since the capability reply of the scan executing unit 25 is transmitted to the printing apparatus terminal 30 and the reading execution condition of the scan executing unit 25 is set in the printing apparatus terminal 30, the print contents which are more suitable for the printing apparatus terminal 30 can be transmitted to the printing apparatus terminal 30. Accordingly, it is possible to print the print contents via the IP network 11 more appropriately.

The transmitting terminal 20 transmits the reply to the request of the print apparatus terminal 30 to the print apparatus terminal 30 after the establishment of the connection with the printing apparatus terminal 30, while functioning as a server in the client-server model. On the other hand, the printing apparatus terminal 30 transmits the request to the transmitting terminal 20, while functioning as a client in the client-server model. Therefore, by transmitting and receiving the print contents under the control of the printing apparatus terminal 30, it is possible to transmit and receive the print contents in accordance with the capability of the printing apparatus terminal 30. Accordingly, it is possible to print the print contents via the IP network 11 more appropriately. Moreover, the transmitting terminal 20 transmits as the capability reply at least one of the resolution with which the image is read, the readable color kind, and the encoding type with which the print contents are generated, to the printing apparatus terminal 30. The printing apparatus terminal 30 sets the reading execution condition in accordance with the capability reply. Therefore, it is possible to print the print contents more appropriately. The transmitting terminal 20 transmits the capability reply of which the range is restricted in accordance with the document size to the printing apparatus terminal 30. Therefore, it is possible to transmit the appropriate capability reply by using the document size and it is possible to print the print contents more appropriately. Since the print quality and the size of the print sheet are used as the setting regarding the print executing unit 34, it is possible to print the print contents more appropriately.

The invention is not limited to the above-described embodiment, but may be modified in various forms within the technical scope of the invention.

For example, in the above-described embodiment, the transmitting terminal 20 transmits the reply to the request of the printing apparatus terminal 30 to the printing apparatus terminal 30, while functioning as the server in the client-server model after the establishment of the connection with the printing apparatus terminal 30. On the other hand, the printing apparatus terminal 30 transmits the request to the transmitting terminal 20, while functioning as the client in the client-server model. However, the invention is not particular to thereto. For example, the transmitting terminal 20 may transmit the reply of the printing apparatus terminal 30 to the printing apparatus terminal 30, while functioning as a client in the client-server model after the establishment of the connection with the printing apparatus terminal 30. On the other hand, the printing apparatus terminal 30 transmits the request to the transmitting terminal 20, while functioning as a server in the client-server model. In this case, in the above-described routine of the reading data transmitting process, step S120 may be omitted. The capability reply may be transmitted to the printing apparatus terminal 30 in step S130 subsequent to the call control process of step S110. In addition, in the above-described routine of the reading data printing process, step S210 is omitted. The call control process may be executed in step S200 and the process may wait until the capability reply may be received in step S220.

In the above-described embodiment, the transmitting terminal 20 transmits the capability reply of which the range is restricted in accordance with the document size to the printing apparatus terminal 30. However, the invention is not limited thereto as the information regarding on the document. For example, the capability reply of which the range is restricted in accordance with the kind of the image of the document may be transmitted to the printing apparatus terminal 30 or other conditions may be added. Examples of the kind of the image include a document, a photo, and a complex image of the document and the photo.

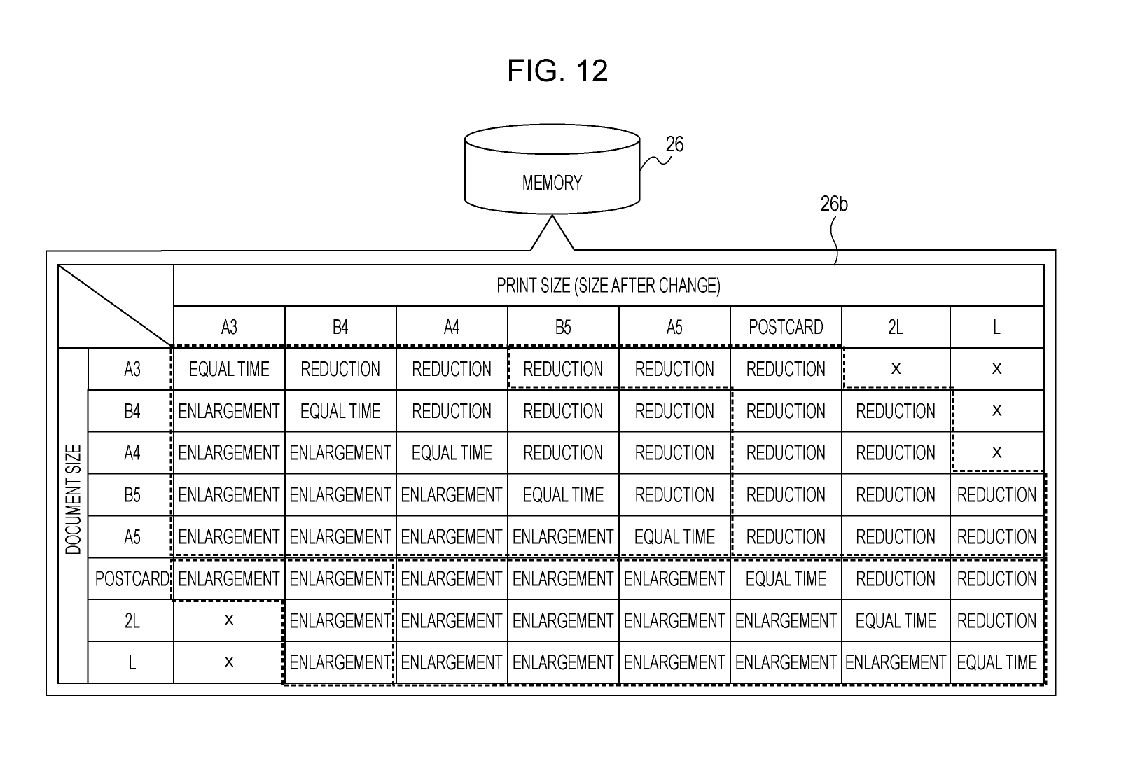

In the above-described embodiment, the capability reply of the scan executing unit 25 is restricted by using the capability setting information 26a in which the relation between the size of the document sheet and the generated image size is fixed. However, as shown in FIG. 12, capability setting information 26b may be used to change the relation between the size of the document sheet and the generated image size in accordance with the kind of image of a document. FIG. 12 is an explanatory diagram illustrating an example of the capability setting information 26b. The capability setting information 26b is restricted like the above-described capability setting information 26a when the document contains characters in a case where the document size is the general A4 size, for example. However, when the document contains no character, the reduction to the postcard size or the 2L size is allowed, as indicated by a thick dot line. For example, when the document contains characters in a case where the document size is the general 2L size, the capability setting information is restricted like the above-described capability setting information 26a. However, when the image of the document is a photo, the reading resolution is increased and the enlargement to the B4 size to be allowed, as indicated by the thick dot line. The kind of image of the document may be determined by executing pre-scan on the document, for example, the detecting sensor 25a capable of detecting the kind of image may be provided.

In the above-described embodiment, the transmitting terminal 20 generates the capability reply of the scan executing unit 25 which includes at least one of the resolution with which the image is read, the readable color kind, and the encoding type with which the print contents are generated. However, the invention is not limited thereto. One or more thereof may be used or the information regarding the capability of the scan executing unit 25 may be added.

In the above-described embodiment, the reading execution condition is set by using the print quality and the size of the print sheet as the setting regarding the print executing unit. However, the invention is not limited thereto. For example, one or more thereof may be used or another condition such as the kind of print sheet may be added. Examples of the kind of print sheet include a normal sheet, a mat sheet, and a photo sheet. The reading execution condition of the scan executing unit 25 is set by using the reading print condition setting information 36a, but the invention is not limited thereto.

In the above-described embodiment, the printing apparatus terminal 30 prints the print contents as soon as receiving the print contents. However, the time at which the printing is performed is not particularly limited, as long as the print executing unit 34 reads an image appropriately and then the print executing unit 34 executes the printing. The print contents may be stored in a storage medium such as the memory 36 or the memory card 38 to execute the printing.

In the above-described embodiment, the execution condition of the scan executing unit 25 executing the reading process of reading the image of the document and generating the print contents is set in the printing apparatus terminal 30. However, the execution condition in which the controller 22 executes the changing process of changing at least one of the resolution of the image data, the image size, the color kind, and the encoding type may be set in the printing apparatus terminal 30. The image data may be stored in the memory 26 or may be stored in the memory card 28. In this case, the transmitting terminal 20 may generate the capability reply containing at least one of the changeable resolution, the image size, the color kind, and the encoding type. In this way, since the print contents changed in accordance with the capability of the printing apparatus terminal 30 can be received by the printing apparatus terminal 30, it is possible to print the print contents more appropriately.

In the above-described embodiment, the printing apparatus terminal 30 includes the scan executing unit 35 and the memory card driver 37. However, the printing apparatus terminal may include one of the scan executing unit 35 and the memory card driver 37 or may not include either the scan executing unit 35 or the memory card driver 37. The transmitting terminal 20 servers as the printer including the print executing unit 24, the scan executing unit 25, and the memory card driver 27. However, the invention is not limited thereto as long as the transmitting terminal has a configuration executing the regarding the print contents. The transmitting terminal may not include one or more of the print executing unit, the scan executing unit, and the memory card driver.

In the above-described embodiment, the controller 22 controls the print executing unit 24 and the scan executing unit 25 and the communication via the I/F 29. However, the control process may be allocated to plural controllers. In the above-described embodiment, the print executing units 24 and 34 serve as the ink jet printing mechanism, but may use a full color electro-photographic method of using a single photosensitive method and an intermediate transfer method. The print executing units 24 and 34 may serve as a color printing mechanism or may serve as a monochrome printing mechanism. In the above-described embodiment, the scan executing units 25 and 35 serve as a flatbed scanner capable of reading a document by scanning a line image sensor. However, the scan executing units may serve as a scanner capable of transporting a document and reading an image formed on the document in a state where a line image sensor is fixed.

In the above-described embodiment, the printing system 10 has been described. A data transmitting method executed by the transmitting terminal 20 may be realized. Alternatively, a printing method executed by the printing apparatus terminal 30 may be realized. Alternatively, a program for the data transmitting method may be realized or a program for the printing method may be realized.

1. A transmitting terminal carrying out communication with a printing apparatus terminal including a print executing unit which prints print data via an IP network, the transmitting terminal comprising:
a process executing unit which executes a process regarding print contents to be transmitted to the printing apparatus terminal;
a first transmitting unit which transmits information;
a first receiving unit which receives information;
a transmitting connection establishment executing unit which establishes connection with the printing apparatus terminal via the first transmitting unit, the first receiving unit, and the IP network; and
a transmitting control unit which allows the first transmitting unit to transmit capability information regarding the process executing unit to the printing apparatus terminal after the establishment of the connection with the printing apparatus terminal, which controls the process executing unit so as to execute the process regarding the print contents on the basis of an execution condition set on the basis of the capability information, when the first receiving unit receives the execution condition of the process executing unit from the printing apparatus terminal after the transmission of the capability information, and which allows the first transmitting unit to transmit the print contents subjected to the process to the printing apparatus terminal,
wherein the transmitting control unit transmits a reply to a request from the printing apparatus terminal to the printing apparatus terminal, while the transmitting terminal functions as a server in a client-server model after the establishment of the connection with the printing apparatus terminal.

2. The transmitting terminal according to claim 1,
wherein the process executing unit executes a reading process of reading an image of a document to generate the print contents as the process regarding the print contents, and
wherein the transmitting control unit transmits at least one of a resolution with which the image is read, a size of the print contents, a readable color kind, and an encoding type with which the print contents are generated to the printing apparatus terminal as the capability information and controls the process executing unit to execute the reading process on the basis of the execution condition upon receiving the execution condition of the process executing unit.

3. The transmitting terminal according to claim 2, wherein the transmitting control unit detects the document before the transmission of the capability information, acquires document information containing at least one of a document size and an image kind of the document, and transmits the capability information restricted in accordance with a range corresponding to the document information to the printing apparatus terminal.

4. The transmitting terminal according to claim 1,
wherein the process executing unit executes a changing process of changing at least one of a resolution, an image size, a color kind, and an encoding type of image data as the process regarding the print contents, and
wherein the transmitting control unit transmits at least one of the resolution, the image size, the color kind, and the encoding type changeable by the process executing unit to the printing apparatus terminal and controls the processing executing unit so as to execute the changing process on the basis of the execution condition upon receiving the execution condition of the process executing.

5. A printing apparatus terminal carrying out communication with a transmitting terminal including a process executing unit executing a process regarding print contents via an IP network, the printing apparatus terminal comprising:
a print executing unit which prints print data;
a second transmitting unit which transmits information;
a second receiving unit which receive information;
a receiving connection establishment executing unit which establishes connection with the transmitting terminal via the second transmitting unit, the second receiving unit, and the IP network; and
a receiving control unit which sets an execution condition of the process executing unit on the basis of capability information regarding the process executing unit and setting regarding the print executing unit, when the second receiving unit receives the capability information after the establishment of the connection with the transmitting terminal, which allows the second transmitting unit to transmit the set execution condition to the transmitting terminal, and which controls the print executing unit to print print-contents processed by the process executing unit on the basis of the setting regarding the print executing unit, when the second receiving unit receives the print contents after the transmission of the execution condition,
wherein the receiving control unit transmits a request to the transmitting terminal, while the printing apparatus terminal functions as a client in a client-server model after the establishment of the connection with the transmitting terminal.

6. The printing apparatus terminal according to claim 5, wherein the receiving control unit sets the execution condition by using at least one of a print quality, a kind of print medium on which printing is executed, and a size of the print medium as the setting regarding the print executing unit.

7. A printing system connected via an IP network comprising:
the transmitting terminal according to claim 1; and
the printing apparatus terminal according to claim 5.

8. The printing system according to claim 7,
wherein the IP network is a next generation network (NGN), and
wherein the connection between the transmitting terminal and the printing apparatus terminal is established by a session initiation protocol (SIP)
